(19) United States
(12) Patent Application Publication
(10) Pub. No.: US 2015/0170343 A1
(43) Pub. Date: Jun. 18, 2015

(54) HEAD-UP DISPLAY APPARATUS AND METHOD FOR VEHICLE

(71) Applicants: Hyundai Motor Company, Seoul (KR); Kia Motors Corporation, Seoul (KR)

(72) Inventor: Hee Chon Kwak, Seoul (KR)

(73) Assignees: KIA MOTORS CORPORATION, Seoul (KR); HYUNDAI MOTOR COMPANY, Seoul (KR)

(21) Appl. No.: 14/296,882

(22) Filed: Jun. 5, 2014

(30) Foreign Application Priority Data
Dec. 18, 2013 (KR) 10-2013-0158548

(51) Int. Cl. G06T 5/00; G02B 27/01

(52) U.S. Cl. CPC G06T 5/006; G02B 27/0101; G02B 2027/011; G02B 2027/014; G06T 2207/20172

(57) ABSTRACT

A head-up display apparatus and method for a vehicle are provided. The apparatus includes a display panel that displays operation information regarding a vehicle in a form of an image and a mirror that projects the image onto a windshield glass of the vehicle. An operation switch adjusts a height of the image projected onto the windshield glass based on a plurality of height adjustment steps. A rotation motor rotates the mirror at a predetermined angle based on a selected height adjustment step from the plurality of height adjustment steps. In addition, a controller operates the display panel according to correction information, based on which distortion of the image is corrected, in response to the selected height adjustment step.

### CROSS-REFERENCE TO RELATED APPLICATION

This application claims priority to and the benefit of Korean Patent Application No. 10-2013-0158548 filed in the Korean Intellectual Property Office on Dec. 18, 2013, the entire contents of which are incorporated herein by reference.

### BACKGROUND

(a) Field of the Invention

The present invention relates to a head-up display apparatus and method for a vehicle, and more particularly, to a head-up display apparatus that adjusts a position of an image projected onto a windshield glass to correspond to a height of driver eyes and corrects distortion of the image for each projection position of the image.

(b) Description of the Related Art

Various systems have been developed as medium for effectively transferring vehicle driving information, surrounding situation information, and the like to a driver, to ensure safety for the driver while the vehicle is being driven, and among them, a head-up display (HUD) apparatus has become a major focus.

The head-up display apparatus is an apparatus that provides operation information about a vehicle, such as driving information or navigation information of the vehicle, at a front side of a driver, that is, within a range without departing from a main view line of the driver, when the vehicle or an air plane is traveling. The head-up display apparatus projects the operation information about the vehicle onto a windshield glass portion at a front side of the driver in a form of a graphic image. The head-up display apparatus provides a function of vertically adjusting a height, at which the graphic image is projected onto the windshield glass, according to a height of the driver eyes. However, since a curved surface of the windshield glass is not uniform, the graphic image may be distorted.

The above information disclosed in this section is merely for enhancement of understanding of the background of the invention and therefore it may contain information that does not form the prior art that is already known in this country to a person of ordinary skill in the art.

### SUMMARY

The present invention provides a head-up display apparatus and method that adjust a position of an image projected onto a windshield glass so as to correspond to a height of the driver eyes, and correcting distortion of the image for each projection position of the image.

An exemplary embodiment of the present invention provides a head-up display apparatus for a vehicle, that may include: a display panel configured to display operation information regarding a vehicle in a form of an image; a mirror configured to project the image onto a windshield glass of the vehicle; an operation switch configured to adjust a height of the image projected onto the windshield glass based on a plurality of height adjustment steps; a rotation motor configured to rotate the mirror at a predetermined angle based on a selected height adjustment step among the plurality of height adjustment steps; and a controller configured to operate the display panel according to correction information, based on which distortion of the image is corrected, in response to the selected height adjustment step.

In particular, the controller may be configured to detect a current height of the image by counting the number of rotations of the rotation motor, determine whether the current height of the image reaches a predetermined reference height, and operate the display panel when the current height reaches the reference height. Further, the controller may be configured to set a substantially middle point of a target height to the reference height based on the target height that corresponds to each of the height adjustment steps. Further, the correction information may be information based on which a two-dimensional (2D) distorted form of the image displayed on the windshield glass is vertically and horizontally reversed. Additionally, the controller may be configured to physically rotate the display panel according to the reversed distorted form. The controller may also be configured to adjust an output position of the image output from the display panel according to the reversed distorted form.

The head-up display apparatus may further include an image correction unit configured to obtain a plurality of images displayed on the windshield glass at a height that corresponds to each of the plurality of height adjustment steps, detect distortion of each of the plurality of images, convert the distorted images into the 2D distorted forms, and generate and store the correction information according to the 2D distorted form.

According to the exemplary embodiment of the present invention, it may be possible to adjust a position of an image projected onto a windshield glass to correspond to a height of the driver eyes, and correct distortion of the image for each a projection position of the image.

### BRIEF DESCRIPTION OF THE DRAWINGS

FIG. 1 is an exemplary diagram illustrating a head-up display apparatus according to an exemplary embodiment of the present invention;

FIG. 2 is an exemplary flowchart illustrating a method of driving the head-up display apparatus according to the exemplary embodiment of the present invention; and

FIG. 3 is an exemplary diagram illustrating correction of distortion of an image according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising,” will be understood to imply the inclusion of stated elements but not the exclusion of any other elements.

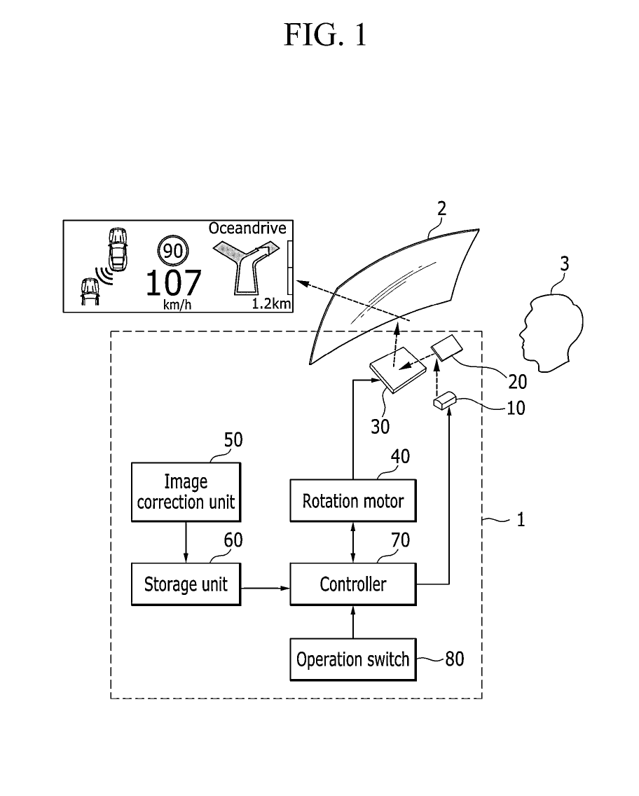

Hereinafter, the present invention will be described more fully hereinafter with reference to the accompanying drawings, in which exemplary embodiments of the invention are shown. FIG. 1 is an exemplary diagram illustrating a head-up display apparatus according to an exemplary embodiment of the present invention. Referring to FIG. 1, a head up display apparatus 1 according to an exemplary embodiment of the present invention may include a display panel 10, a first mirror 20, a second mirror 30, a rotation motor 40, an image correction unit 50, a storage unit 60, a controller 70, and an operation switch 80.

The display panel 10 may be executed by the controller 70 to display operation information regarding a vehicle including various driving information, navigation information, and the like in a form of an image. The first mirror 20 may be configured to reflect the image output from the display panel 10, and the second mirror 30 may be configured to project the image reflected by the first mirror 20 onto a windshield glass 2. A driver 3 may view the graphic image projected onto the windshield glass 2. In particular, the first mirror 20 may be a plane mirror, and the second mirror 30 may include an aspherical mirror.

The rotation motor 40 may be coupled with the second mirror 30, and may be executed by the controller 70 to rotate the second mirror 30 at a predetermined angle. In particular, the rotation motor 40 may include a step motor. The image correction unit 50 may be executed by the controller 70 to detect distortion of an image based on a height of the image that corresponds to a height adjustment step. The image correction unit 50 may be configured to generate correction information, based on which the detected distortion of the image is corrected, and store the generated correction information in the storage unit 60 (e.g., a memory).

Particularly, the image correction unit 50 may be executed by the controller 70 to obtain an image at a predetermined target height for each height adjustment step, and convert the obtained image into a 2D distorted form. Further, the image correction unit 50 may be configured to generate a vertically reversed form of the 2D distorted form as the correction information. In particular, the image correction unit 50 may be configured to extract the 2D distorted form of the image by simulating and obtaining the image for each target height using a curved shape of the windshield glass 2 or photographing an image for each target height in the vehicle.

The controller 70 may be configured to determine a target height of the image that corresponds to the height adjustment step selected by the operation switch 80, and extract the correction information regarding the corresponding target height from the storage unit 60. Further, the controller 70 may be configured to operate the rotation motor 40 according to the target height of the image. The controller 70 may be configured to determine a current height of the image by counting the number of rotations of the rotation motor 40 during the driving of the rotation motor 40. The controller 70 may further be configured to determine whether the current height of the image reaches a predetermined reference height, and when the current height of the image reaches the predetermined reference height, the controller 70 may be configured to correct the distortion of the image based on the extracted correction information.

In particular, the controller 70 may be configured to set a substantially middle point of the target height for each height adjustment step to a reference height. In other words, the controller 70 may be configured to set the number of rotations of the rotation motor 40 for each height adjustment step, and when the rotation motor 40 rotates half (½) of the number of rotations of the corresponding height adjustment step, the controller 70 may be configured to determine that the image reaches the predetermined reference height. Further, the controller 70 may be configured to adjust the image to be output in an opposite direction to that of the 2D distorted form from the display panel 10, or may be configured to rotate the display panel 10.

The operation switch 80 may include a plurality of height adjustment steps operated by the driver 3. In particular, the operation switch 80 may include a scroll type button, and the height adjustment step may be sequentially selected. For example, when the height adjustment step is stage 3, the operation switch 80 may be operated in an order of steps 1, 2, and 3, or a reverse order. The exemplary embodiment of the present invention is not limited thereto, and the operation switch 80 may be a push type button.

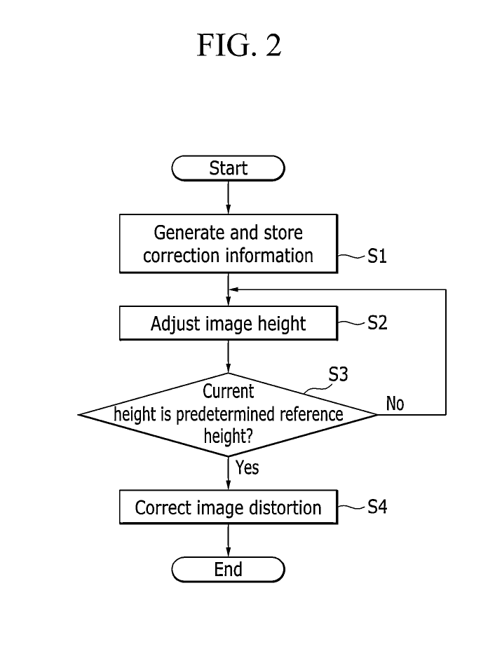

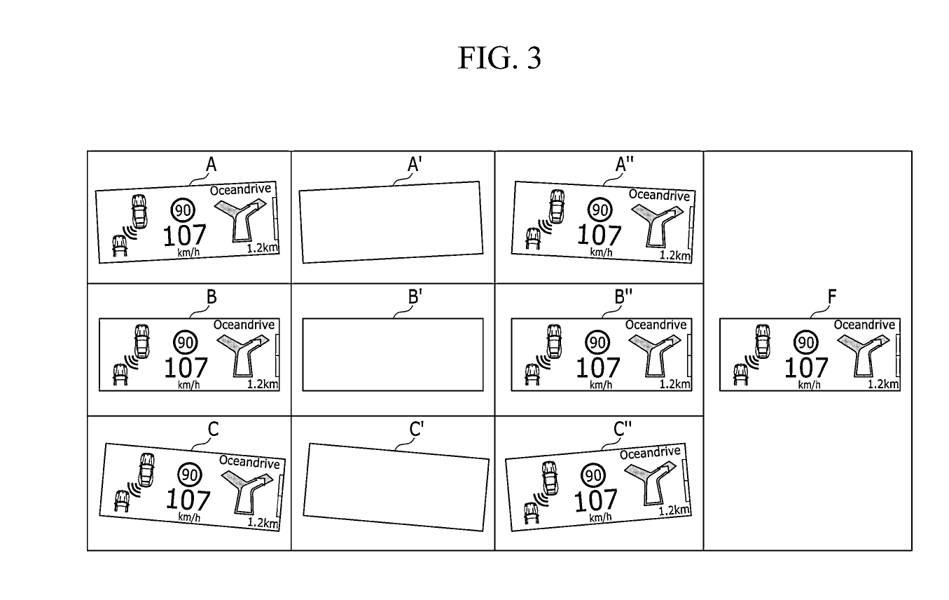

FIG. 2 is an exemplary flowchart illustrating a method of driving the head-up display apparatus according to the exemplary embodiment of the present invention, and FIG. 3 is an exemplary diagram illustrating correction of distortion of an image according to the exemplary embodiment of the present invention.

Referring to FIG. 2, the image correction unit 50 may be executed by the controller 70 to store the correction information that corresponds to each height adjustment step in the storage unit 60 (step S1). For example, as illustrated in FIG. 3, when the height adjustment step is steps 1, 2, and 3, the image correction unit 50 may be configured to obtain first to third images A, B, and C that correspond to the respective steps. Further, the image correction unit 50 may be configured to extract 2D distorted forms A′, B′, and C′ by calculating a distortion degree of each of the first to third images A, B, and C. In particular, the distorted form B′ of the second image B may be a normal form having no distortion. Further, it can be seen that in the distorted forms A′ and C′ of the first and third images A and C, the distortion may be generated by a curved surface of the windshield glass 2 in a predetermined direction.

Additionally, a starting key may be on, and the operation switch 80 may be operated to allow the height adjustment step to be selected (step S2). Then, the controller 70 may be configured to start adjustment of the height of the image by driving the rotation motor 40 according to the selected height adjustment step (step S3). For example, when a target height of step 1 corresponds to an upper region of the windshield glass 2, a target height of step 2 corresponds to a substantially center region of the windshield glass 2, and the height adjustment step may be adjusted from step 1 to step 2, the height of the image may be adjusted from the upper region to the center region of the windshield glass 2.

Furthermore, the controller 70 may be configured to detect a current height of the image by counting the number of rotations of the rotation motor 40, and determine whether the current height of the image reaches a predetermined reference height (step S4). As a result of the determination, when the current height of the image reaches the predetermined reference height, the controller 70 may be configured to extract correction information that corresponds to the selected height adjustment step from the storage unit 60.

In addition, the controller 70 may be configured to correct the distortion of the image according to the extracted correction information (step S5). For example, the controller 70 may be configured to physically or graphically operate the display panel 10 to output images A″, B″, and C″, which are vertically and horizontally inversed forms of the 2D distorted forms A′, B′, and C′, as illustrated in FIG. 3. Accordingly, a final image F viewed by the driver may be normally displayed (e.g., with no or minimal distortion) regardless of the height of the image. Further, the driver may not feel a change in the image by correcting the distortion of the image during the height adjustment of the image. The distortion of the image may be corrected for each step whenever the height adjustment step is adjusted by repeating the aforementioned process, to allow the final image F to be displayed in a distortion corrected state when the image reaches a target position desired by the driver.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

10: Display panel
20: First mirror
30: Second mirror
40: Rotation motor
50: Image correction unit
60: Storage unit
70: Controller
80: Operation switch

What is claimed is:

1. A head-up display apparatus for a vehicle, comprising:
a display panel configured to display operation information regarding a vehicle in a form of an image;
a mirror configured to project the image onto a windshield glass of the vehicle;
an operation switch configured to adjust a height of the image projected onto the windshield glass based on a plurality of height adjustment steps;
a rotation motor configured to rotate the mirror at a predetermined angle based on a selected height adjustment step from the plurality of height adjustment steps; and
a controller configured to operate the display panel according to correction information, based on which distortion of the image is corrected, in response to the selected height adjustment step.

2. The head-up display apparatus of claim 1, wherein:
the controller is configured to:
detect a current height of the image by counting the number of rotations of the rotation motor;
determine whether the current height of the image reaches a predetermined reference height; and
operate the display panel at a time when the current height reaches the reference height.

3. The head-up display apparatus of claim 2, wherein:
the controller is configured to set a substantially middle point of a target height to the reference height based on the target height that corresponds to each of the height adjustment steps.

4. The head-up display apparatus of claim 1, wherein:
the correction information is information based on which a two-dimensional (2D) distorted form of the image displayed on the windshield glass is vertically and horizontally reversed.

5. The head-up display apparatus of claim 4, wherein:
the controller is configured to rotate the display panel according to the reversed distorted form.

6. The head-up display apparatus of claim 4, wherein:
the controller is configured to adjust an output position of the image output from the display panel according to the reversed distorted form.

7. The head-up display apparatus of claim 4, wherein:
the controller is configured to:
obtain a plurality of images displayed on the windshield glass at a height that corresponds to each of the plurality of height adjustment steps;
detect distortion of each of the plurality of images;
convert the distorted images into the 2D distorted forms; and
generate and store the correction information according to the 2D distorted form.

8. A head-up display method for a vehicle, comprising:
displaying, by a controller, operation information regarding a vehicle in a form of an image on a display panel;
projecting, by a mirror, the image onto a windshield glass of the vehicle;
adjusting, by the controller, a height of the image projected onto the windshield glass based on a plurality of height adjustment steps by operating an operation switch;
rotating, by the controller, the mirror at a predetermined angle based on a selected height adjustment step from the plurality of height adjustment steps by operating a rotation motor; and
operating, by the controller, the display panel according to correction information, based on which distortion of the image is corrected, in response to the selected height adjustment step.

9. The method of claim 8, further comprising:
detecting, by the controller, a current height of the image by counting the number of rotations of the rotation motor;
determining, by the controller, whether the current height of the image reaches a predetermined reference height; and
operating, by the controller, the display panel at a time when the current height reaches the reference height.

10. The method of claim 9, further comprising:
setting, by the controller, a substantially middle point of a target height to the reference height based on the target height that corresponds to each of the height adjustment steps.

11. The method of claim 8, wherein the correction information is information based on which a two-dimensional (2D) distorted form of the image displayed on the windshield glass is vertically and horizontally reversed.

12. The method of claim 11, further comprising:
rotating, by the controller, the display panel according to the reversed distorted form.

13. The method of claim 11, further comprising:
adjusting, by the controller, an output position of the image output from the display panel according to the reversed distorted form.

14. The method of claim 11, further comprising:
obtaining, by the controller, a plurality of images displayed on the windshield glass at a height that corresponds to each of the plurality of height adjustment steps;
detecting, by the controller, distortion of each of the plurality of images;
converting, by the controller, the distorted images into the 2D distorted forms; and
generating and storing, by the controller, the correction information according to the 2D distorted form.

15. A non-transitory computer readable medium containing program instructions executed by a processor or controller, the computer readable medium comprising:
program instructions that display operation information regarding a vehicle in a form of an image on a display panel;
program instructions that project the image onto a windshield glass of the vehicle;
program instructions that adjust a height of the image projected onto the windshield glass based on a plurality of height adjustment steps by operating an operation switch;
program instructions that rotate the mirror at a predetermined angle based on a selected height adjustment step from the plurality of height adjustment steps by operating a rotation motor; and
program instructions that operate the display panel according to correction information, based on which distortion of the image is corrected, in response to the selected height adjustment step.

16. The non-transitory computer readable medium of claim 15, further comprising:
program instructions that detect a current height of the image by counting the number of rotations of the rotation motor;
program instructions that determine whether the current height of the image reaches a predetermined reference height; and
program instructions that operate the display panel at a time when the current height reaches the reference height.

17. The non-transitory computer readable medium of claim 16, further comprising:
program instructions that set a substantially middle point of a target height to the reference height based on the target height that corresponds to each of the height adjustment steps.

18. The non-transitory computer readable medium of claim 15, wherein the correction information is information based on which a two-dimensional (2D) distorted form of the image displayed on the windshield glass is vertically and horizontally reversed.

19. The non-transitory computer readable medium of claim 18, further comprising:
program instructions that rotate the display panel according to the reversed distorted form.

20. The non-transitory computer readable medium of claim 18, further comprising:
program instructions that adjust an output position of the image output from the display panel according to the reversed distorted form.
